(19) United States
(12) Patent Application Publication
(10) Pub. No.: US 2014/0279379 A1
(43) Pub. Date: Sep. 18, 2014

(54) FIRST PARTY FRAUD DETECTION SYSTEM

(71) Applicants: Rami Mahdi, San Diego, CA (US); Darwin Villagomez, San Diego, CA (US); Christopher Jones, Escondido, CA (US)

(72) Inventors: Rami Mahdi, San Diego, CA (US); Darwin Villagomez, San Diego, CA (US); Christopher Jones, Escondido, CA (US)

(21) Appl. No.: 13/804,023

(22) Filed: Mar. 14, 2013

(51) Int. Cl. G06Q 40/02

(52) U.S. Cl. CPC G06Q 40/025
USPC 705/38

(57) ABSTRACT

The present invention provides, in at least one embodiment, a system, and method for detecting first party fraud. When a fraudulent consumer fills out a current application for a discounted commodity, such as cell phone, the system searches for prior applications with the same or similar (i.e., matching) identity information. Based on these matches (i.e., identity linking keys), the system generates marker variables indicative of first party fraud. For example, markers can be the number of matching applications filed for a commodity within a given time period. Lastly, the system outputs a risk score based on the markers. The risk score represents the chance that the current application represents first party fraud.

### BACKGROUND OF THE INVENTION

1. Field of Invention

The invention relates generally to fraud detection, and more particularly, to a technique for detecting first party fraud.

2. Description of Related Art

It is estimated that over fifty (50) billion dollars have been lost by U.S. consumers and businesses annually since 2009 as a result of identity theft and fraud. The good news is that consumers are generally becoming more aggressive in monitoring, detecting, and preventing fraud with the help of technology and partnerships with financial institutions, government agencies, and identity theft protection companies. Numerous identity theft protection companies have been formed in recent years in order to provide subscribers with notifications to alert and resolve actual or potential identity misuse in, for example, credit applications, utility transactions, check orders, and payday loans, as well as provide resources to restore the subscriber's identity and recover any direct losses as a result of identity theft.

Most of the fraud is third party fraud. Third party fraud happens when a third party impersonates the genuine identity of another, i.e., the true owner of that identity, often to apply for credit or use of the owner's existing credit. When the owner discovers that they have become a victim of identity fraud, they typically have some financial loss and a significant amount of work to clean up the mess. Third party fraud typically gets a large amount of media coverage, as third party fraud can be perpetuated on not just one person, but a large amount of people. Further, the theft or exposure of owner's identity data, even without the any fraudulent use of the identity data, creates a media buzz since these people are now more susceptible to third party fraud.

Financial institutions are getting progressively better at detecting third party fraud. Typically, the institutions use computerized systems to detect the likelihood that the applicants are who they say they are. The computerized systems send the applicants' identity information to external databases, such as credit databases, known fraud databases, application databases, public records databases, etc. These systems use a risk based approach that analyzes the discrepancies between the identity information.

When consumers think of fraud, they are almost always thinking of third party fraud. However, financial institutions are concerned about both first party fraud and third party fraud, since both lead to financial losses. The difference between first party fraud and third party fraud is huge. In first party fraud, the fraudster is using his own identity, or mostly his own identity, to commit the fraud, whereas in third party fraud, the fraudster is using another's identity to commit the fraud. In order words, first party fraud does not involve a stolen identity. At first glance, first party fraud would appear to be a victimless crime, since no other consumer is directly harmed. However, the truth is that this is not a victimless crime, as financial institutions lose millions of dollars each year to people who intentionally defraud them.

This type of fraud is called “first party” because the fraudster is not misrepresenting which person he is, as is the case in many other types of fraud such as traditional identity fraud. The fraudster is presenting himself indeed as himself (i.e., the first party), but he has no intention of paying for the product or service as contractually obligated. This mode of fraud has been in existence for a long time and is also known by or related to other monikers, including true-name fraud, diabolical, and straights.

In first party fraud, the fraudster applies for credit, goods, or services, without the intention to fulfill their payment obligation. In other words, when the fraudster is filling out the application, he has no intention to actually pay later. However, often times, the fraudster will make changes to his identity, or add fictitious information, in order to continue the fraud for a longer period of time. Since financial institutions attempt to detect the likelihood that the applicants are who they say they are, and first party fraudsters obviously satisfy this criteria, first party fraud is very difficult to detect and prevent.

The conventional third party fraud models, which focus on inconsistencies of identity information in their application, fall short of resolving this problem. For example, a third party fraudster who consistently uses the correct identity information would not generally be detected using the third party fraud models. From a financial institutions perspective, the difference between third party fraud and first party fraud is huge. First party fraud depends solely on the intention of the applicants, and whether they actually intend to pay after they get the credit.

The first party fraud starts when the fraudster applies for something, typically an unsecured banking credit line, such as a credit card, loan, or overdraft protection. Even though the fraudster has no intention of paying back the unsecured debt, the fraudsters will often times further the fraud by paying like a normal customer for months or years to further perpetrate the fraud. For example, the fraudster may successfully make credit card payments for one to two years, or until the credit limit is raised, and then commit the fraud all at once. It is not uncommon for a fraudster to spend two years making and paying off large purchases in order to build up their credit score, increase their line of credit, and maximize their eventual earnings.

First party fraud is often committed by criminals who are part of a well-organized fraud network. This fraud network can extend to the employees taking in the applications, such as bank employees. The fraud network can include hiring people who are not concerned about their credit score, such as people who do not intend to stay within the United States.

Another type of first party fraud is often referred to as “credit muling” or “equipment gaming.” This type of fraud occurs when consumers use their true identities and personal information to apply for multiple, high-value products with no intention of honoring their contractual agreements. Mobile phone carriers are favored targets, as they have so many mall outlets and offer heavily subsidized smart phones to those who pass a credit check—phones that are easily transported and resold all over the world at a premium price. Here's how credit muling typically works: fraudsters advertise “employment opportunities” to individuals willing to act as “secret shoppers,” ostensibly to rate the customer service and shopping experience at various branch locations. Fraudsters direct their mule “employees” to shop for expensive smart phones; the mobile phone carriers do their normal credit and fraud checks and send the mule out the door with one or more expensive phones and a signed contract. The mules turn the merchandise over to the fraudster and get assurances that the contract will be terminated. Then they are sent to the next mobile phone store in the mall to repeat the process. Only when the collection letters start coming do the mules realize they have been defrauded. Sometimes the mules are aware of the fraud and are either not concerned with damaging their credit or will later claim they were unaware.

Although the muling activity described above can occur as a group activity, at times it is just a single person. The person tries to get multiple products without committing to payments believing that he is being clever, and there will be no credit or charge consequences or he will be able to avoid those consequences.

Traditionally, attempts to prevent first party fraud are made by a team of professionals examining accounts unpaid accounts and seeing which accounts appear to be fraudulent. However, this approach occurs well after the fraud has occurred, and occurs on such a small sample that it is easy for the fraud to never be detected.

### SUMMARY OF THE INVENTION

The present invention provides, in at least one embodiment, a system, and method for detecting first party fraud. When a fraudulent consumer fills out a current application for a discounted commodity, such as cell phone, the system searches for prior applications with the same or similar (i.e., matching) identity information using real time multidimensional linking technology.

In one embodiment, a system comprises: a current application comprising identity information of a consumer for obtaining for a commodity; a plurality of prior individual applications containing a history of activity of consumers; a search module that searches for matching applications between the current application and the prior individual applications based on one or more identity linking keys, wherein the identity linking keys are matches of identity characteristics between the matching applications; a generation module which generates markers that are indicative of first party fraud based the identity linking keys in the matching applications, wherein the markers comprise a variance among identity information of the identity linking keys in the matching applications, a frequency between the matching applications, or a total number of the matching applications; and a predictive module which computes a risk score based on the markers, wherein the risk score represents a chance that the current application represents first party fraud. The markers may comprise the total number of the matching applications and the variance among identity information of the identity linking keys in the matching applications. The markers may comprise the frequency between the matching applications. The frequency may comprise multiple time windows. The markers may further comprise a type of application. The type of application may comprise unsecured banking credit line application, an overdraft protection application, or a cellphone application. The commodity may be a good or service, wherein the good may be a cellphone and the commodity may be an unsecured line of credit. The unsecured line of credit may comprise a credit card.

In one embodiment, a method comprises the steps of: obtaining identity information from a current application comprising identity information; receiving a history of activity of consumers from a plurality of prior individual applications containing; using a search module that searches for matching applications between the current application and the prior individual applications based on one or more identity linking keys, wherein the identity linking keys are matches of identity characteristics between the matching applications; using a generation module which generates markers that are indicative of first party fraud based the identity linking keys in the matching applications, wherein the markers comprise a variance among identity information of the identity linking keys in the matching applications, a frequency between the matching applications, or a number of the matching applications; and using a predictive module which computes a risk score based on the markers, wherein the risk score represents a chance that the current application represents first party fraud. The markers may comprise the total number of the matching applications and the variance among identity information of the identity linking keys in the matching applications. The markers may comprise the frequency between the matching applications.

In one embodiment, a system comprises: a search module that searches for matching applications between a current application and prior applications based on one or more identity linking keys, wherein the identity linking keys are matches of identity characteristics between the matching applications; a generation module which generates markers that are indicative of first party fraud based the identity linking keys in the matching applications, wherein the markers comprise a variance among identity information of the identity linking keys in the matching applications, a frequency between the matching applications, or a number of the matching applications; and a predictive module which computes a risk score based on the markers. The markers may comprise the total number of the matching applications and the variance among identity information of the identity linking keys in the matching applications. The markers may comprise the frequency between the matching applications.

The linking technology is the matching of identity characteristics (e.g., name, social security number, address, etc.) between the current application and at least one of the prior individual applications. The identity characteristics that actually match between the current and prior applications, are referred to as identity linking keys. The identity linking keys can be name, social security number, address, etc. Additionally, the identity linking keys can be a concatenation of multiple linking keys, such an application the matches both the name and the date of birth. The linking keys, which link matching applications, can be used to form marker variables. Marker variables are useful compilations of the identity linking keys. Marker variables can include, for example, the frequency between the matching applications, the variance between particular identity linking keys, and the types of applications (e.g., cell phones application forms, credit card application forms, etc.)

In other words, based on these matches, the system generates marker variables indicative of first party fraud. These variables are constructed using a graphical network and linking simultaneously on several identity characteristics, such as SSN, address, phone number, name concatenated with date of birth, email. For example, markers can be the number of applications filed for a commodity within a given time period as linked by the email or the address. Lastly, the system outputs a risk score based on the markers. The risk score represents the chance that the current application represents first party fraud.

First party fraud is seen in any industry where a desired product or service is offered at a discounted price with the intent on making up this discount in ongoing subscription payments. It is common in financial services where credit is misused quickly, such as a newly issued credit card with a retail merchant's installment loan. Credit cards are commonly misused during first party fraud.

In the past few years there has been a substantial rise in this fraud mode particularly around the business model of subsidized smart phones. Embodiments of the present invention works well at identifying all these various industry occurrences of such first party fraud.

Although a fraudster might use another person's identity to avoid negative consequences on his credit history (i.e., third party fraud), this is not necessarily the case. A first party fraudster uses his own valid identity to make these applications, and may repeat this many times before his credit history gives him away. It may happen that the victimized business does not report the incident to a credit or collection agency, and hence the fraudster may be able to safely continue hunting for his next free lunch. Those first party fraud applicants also may partially manipulate their identity information (name, date of birth, address, phone, etc.) in an effort to avoid trivial checking via the processes of the targeted business.

Embodiments of the present invention rely on searching for consumer behavior characteristics that are markers (also referred to as indicative markers, marker elements, descriptive and summarization elements, etc.) of a first party fraudulent activity by examining previous events that are linked to the current one via identity linking keys (SSN, address, phone number, name_DOB, email, etc.). Through such an ID Network, having data visibility contributed by enterprise clients, the detection system relies on a number of markers based on the history of the consumer activity.

Those markers can be the frequency of consumer applications linked through identity linking keys, the variance among those applications, the types of those applications and other specific descriptors about those applications. All those markers are quantified using varying time windows in order to have a precise measure of the velocity of transactions made by the client. Starting with many potentially informative markers, the system is trained using a supervised learning algorithm to pick the most informative indicators, which are then used to build the most predictive model out of the given markers. In the embodiments of the current invention, it is important to have such cross business and cross industry visibility into a fraudster's activities.

The system gathers all previous specific events that may have any remote relationship to the applying person, as assembled by these identity linking keys, and use these detailed events to compute the indicative markers. Thus, the system uses a fully-connected network of all retained specific events (e.g., applications) that allow an on-the-fly, real time assembly of pertinent past events in order to construct the indicative markers/variables. This is very different from using a preassembled set of “credit folios” assembled at a person level and allows the creation of much more powerful indicative markers of fraud behavior. The data network contains all past events for all people, addresses, phone numbers etc. observed in the network, essentially covering the entire U.S. These individual, specific historical events are explicitly retained in the network as opposed to summarized into person-level folios. The individual events are then queried via identity linking keys to assemble the relevant events needed to examine for adjudicating the likelihood of fraud on the event being scored.

An advantage of the invention is the system is the use of linking on multiple identity keys as opposed to simply examining a preassembled profile of a person. The system is real time, and some the historical events being assembled may have occurred only minutes previously, which is very difficult for the “preassembled folio” approach to accomplish.

Another advantage of the present invention is that it detects high risk applicants whose goal is to acquire a commodity that is being sold at a subsidized price conditioned on an ongoing subscription to a service or a payment plan, where the applicant has no intention of paying. An example of such a commodity is the high end smart phones (e.g., iPhone) being sold by wireless carriers at subsidized prices with a condition that the buyer must commit to a one or two year service contract. In this example, a first party fraudulent applicant finds this as an opportunity to sign up to as many plans as possible with as many wireless carriers as possible in a short period of time in order to get as many smart phones as possible at the subsidized prices. The applicant can then take those phones and sell them in the market at a higher price without ever making a payment to the plans he signed up for, resulting in a financial loss for the wireless service providers who subsidized the price of the phone.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates first party fraud of a commodity according to an embodiment of the invention;

FIG. 2 illustrates first party fraud of the commodity in FIG. 1 according to an embodiment of the invention;

FIG. 3 illustrates a first party fraud detection system according to an embodiment of the invention;

FIG. 4 illustrates modules of the system of FIG. 3 according to an embodiment of the invention; and

FIG. 5 illustrates the process of detecting first party fraud according to an embodiment of the invention.

### DETAILED DESCRIPTION OF EMBODIMENTS

Further features and advantages of the invention, as well as the structure and operation of various embodiments of the invention, are described in detail below with reference to the accompanying FIGS. 1-5, wherein like reference numerals refer to like elements. Although the invention is described in the context of a plurality of modules, one of ordinary skill in the art readily appreciates that the present invention can be implemented with more or fewer modules (e.g., a single module).

The system receives an incoming application. The system expects to receive identity information of the applicant (e.g., social security number, name, address, phone number, date of birth). The identity information is then cleaned to detect whether identity information could be invalid. The identity network is then queried to retrieve all historical transactions that can be matched using identity linking keys (e.g., links, link sets, combinations of link sets, or similarities) to this identity information. The results of those queries are multiple link sets of historical consumer application records. Using these matches, a number of marker variables that provide summaries about those applications in various times windows are generated. Examples of such variables include the number of applications in the last week/month/year linked by address, SSN or phone, or the number of unique emails used in the last week/month/year linked by the various identity elements described. Finally, the generated variables (referred to herein as markers) are fed into the predictive model to compute the similarities among the current application and other applications of previously known fraudsters and non-fraudsters. The model then output a risk score based on this similarity.

ID Analytics, Inc. (a wholly owned subsidiary of LifeLock, Inc.) utilizes its proprietary ID Network®—the only real time, cross-industry compilation of identity information—to glean insight into consumer identity behavior. The ID Network has grown to include over 700 billion aggregated identity attributes (“characteristics”), 2.9 million reported frauds, and 1.7 billion consumer transactions. The ID Network receives an average daily flow of over 45 million attributes via a constant stream of input from its members, including leading financial institutions, retailers, wireless providers, credit card issuers, auto and mortgage lenders, and other issuers of credit. This insight reveals, among other things, anomalous and potentially fraudulent activity. Every day, the largest U.S. companies and critical government agencies rely on ID Analytics to make risk-based decisions that enhance revenue, reduce fraud, drive cost savings and protect consumers.

ID Analytics has also developed and implemented an ID Score, which is a numeric value ranging from 001-999 and reflects the risk-level associated with a consumer's identity, i.e., the likelihood the consumer has been victimized by an identity thief—the greater the score, the greater the risk. The ID Score relies on data within the ID Network and provides an integrated view of each individual's identity characteristics and their connectedness to others' identity characteristics. These identity characteristics include, among other possible pieces of consumer data, Social Security number (SSN), name, address, home phone number, date of birth, cell phone number, e-mail address, and Internet Protocol (IP) address. The ID Score helps organizations effectively pinpoint first-party fraud, synthetic identities, and identity theft in real time. The technology behind the ID Network, ID Score, and applications thereof are discussed in United States Patent Application Publication No. 2006/0149674; and U.S. Pat. Nos. 7,458,508; 7,562,814; 7,686,214; and 7,793,835, the entire disclosures of which are all incorporated by reference herein. By applying advanced analytics to data within the ID Network, ID Analytics can quantitatively evaluate millions of desirable and suspicious behaviors and relationships in real time to understand identity risk. These analytics generate immediate and actionable insight including the authenticity of an identity, an applicant's creditworthiness, or a consumer's exposure to identity theft.

FIG. 1 illustrates first party fraud of a commodity 110 according to an embodiment of the invention. FIG. 1 illustrates a consumer 105, the commodity 110, a merchant 115, and a current application 120. FIG. 1 illustrates an example of first party fraud where the consumer 105 fraudulently obtains a commodity at a contractually discounted rate with no intention of actually fully paying for it later or fulfilling the life of the contract.

The consumer 105 (e.g., fraudulent consumer, fraudster, etc.) may be intending to commit first party fraud. A fraudulent consumer is willing to ruin his own credit in order to defraud the merchant 115 or a large group of merchants. In this instance, the exemplary commodity 110 is a cellphone. High end smart phones, such as the iPhone, are being sold by wireless carriers at subsidized prices with a condition that the buyer must commit to a one or two year service contract.

The merchant 115 is a company that is providing or selling the commodity 110. If the commodity is a cellphone, the merchants include the many wireless providers (e.g., Verizon, AT&T, etc.) and the stores which sell cellphones (e.g., Target). The merchants also include the countless locations for each of the wireless providers and stores. First party fraud can occur wherever these desired products are sold.

The current application 120 (e.g., application 120) is filled out by the consumer 105. If this is the consumer's first ever fraudulent application, using accurate information, the merchant 115 would not be able to catch the fraud at this stage. However, if the consumer 105 has completed many, or even some, prior applications, especially if they are within a short time window, embodiments of the present invention detect this activity.

FIG. 2 illustrates first party fraud of the commodity in FIG. 1 according to an embodiment of the invention. FIG. 2 illustrates that there is often a criminal element 225 involved in first party fraud, where a fraudulent consumer can take the commodity 110 to the criminal elements 225, and the criminal element 225 sells the commodity 110 locally or abroad.

The criminal element 225 can be a fraud ring or some other organization specializing in crime. The consumer 105 can be a significant part of the criminal element 225, or the consumer 105 can be a disposable part who is just looking to make a quick profit. In one embodiment, the criminal element 225 is waiting outside the merchant's store for the consumer 105, such that they can load the commodity 110 into a truck 230 or van. The commodities 105 may be shipped by plane 235 to another country (e.g., China) for sale.

FIG. 3 illustrates a first party fraud detection system 300 according to an embodiment of the invention. The system 300 includes the current application 120 having identity information 340. The system 300 also includes an identity graphical network 345.

The system 300 detects first party fraud based on a predictive score on the current application 120 based on linking to one or more prior applications using one or several of the identity elements as linking keys. In one embodiment, marker variables are created from the current and linked prior applications, and these marker variables are inputs to previously-trained supervised machine learning models.

The identity information 340 may include the consumer's name, address, social security number, date of birth, phone number, etc. When the same, or similar, identity information 340 is frequently used in a close proximity of time for the same or another commodity 110, this is evidence of first party fraud.

The identity network 345 (also known as identity network, ID Analytics network, ID graphical network, IDA database, etc.) includes, or is coupled to, one or more modules that determine the likelihood that the current application 120 represents first party fraud.

FIG. 4 illustrates modules 450-465 of the system 300 of FIG. 3 according to embodiments of the invention. The modules 450-465 include a historical module 450, a search module 455, a generator module 460, and a predictive module 465. The modules 450-465 may be located in, or coupled to, the identity network 345.

The historical module 450 contains identity information from prior applications 470. The prior applications 470 can include applications from a large numbers of consumers in the identity network 345, although in other embodiments can be defined as just the prior applications that match or are similar to the current application 120. The prior applications 470 can include both applications of previously known fraudsters and applications of non-fraudsters.

The search module 455 (e.g., search and compare module) compares the identity information in the current application 120 to the prior applications 470. In one embodiment, the search module 455 searches for exact matches of identity information (e.g., social security number, name, address, phone number, date of birth). In another embodiment, the search module 455 searches for near matches (e.g., similar matches) as well. In another embodiment, the search is made using special combinations of linking keys, such as a concatenation of last name and date of birth, or zip code and the last name, etc.

The generator module 460 analyzes the search results from the search module 455 and compiles one or more markers that are indicative of first party fraud. The markers (e.g., generated variables, marker variables, etc.) can include the frequency of the linked applications, the variance between the current and prior applications, the types of linked applications, the total number of linked applications, the timing between these applications, etc. For example, the variance of identity information (e.g., entropy) between matching applications is a good indicator of first party fraud. Frequency of the linked application is an amount of matching applications over a period of time.

In one embodiment, the generated variables include the number of linked applications in the last week, the last month, and the last year. In another embodiment, the generated variable includes the number of unique email addresses used in the last week, the last month, and the last year. The frequency of the applications is an amount of linked applications over a period of time. For example, many applications applied for within the recent past raises the likelihood of fraud. The frequency/frequencies of the applications that match (e.g., matching application, linked applications) is analyzed. The matching applications are analyzed over one, or multiple, time windows (i.e., given periods of time).

The system 300 detects fraud, based on time, by using a variety of frequency measures. In one embodiment, markers include the number of one particular identity characteristic linked to another identity characteristic over a particular number of days. For example, this concatenation of identity characteristics maybe the number of matching application having both the same phone number and social security number over the past 10 days. The identity characteristics can be home phone number, dates of birth, merchants, emails, etc. The particular number of days can be 1, 10, 30, or any other number.

The predictive module 465 outputs a risk score. The risk score represents the chance that the current application represents first party fraud. The predictive module 465 computes the risk score based on the markers (i.e., generated variables). The calculated markers are inputs to standard supervised machine learning algorithms built using examples of previous fraud attempts. These standard machine learning algorithms can include neural networks, support vector machines, boosted trees or regressions.

FIG. 5 illustrates the process of detecting first party fraud according to an embodiment of the invention. The process starts at step 500. At step 510, the search module 455 receives input identity characteristics from the current application 120. Then, at step 520, the search module 455 compares the identity information from the current 120 to the identity information from the prior applications 470 in the ID Network 345. This comparison generates a multitude of linking keys (e.g., SSN, phone, email, name_DOB, name_address, etc.) and are used to link to the repository of previous applications 450. These linked applications are assembled for the next step.

At step 530, the generator module 460 computes markers that are indicative of first party fraud using the linking keys assembled at step 520. The markers can include the frequency of applications over a given period of time as described above. At step 540, the predictive model 465 computes and outputs a risk score based on the predictive algorithm using the generated indicative markers.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A system comprising:
a current application comprising identity information of a consumer for obtaining for a commodity;
a plurality of prior individual applications containing a history of activity of consumers;
a search module that searches for matching applications between the current application and the prior individual applications based on one or more identity linking keys, wherein the identity linking keys are matches of identity characteristics between the matching applications;
a generation module which generates markers that are indicative of first party fraud based the identity linking keys in the matching applications, wherein the markers comprise a variance among identity information of the identity linking keys in the matching applications, a frequency between the matching applications, or a total number of the matching applications; and
a predictive module which computes a risk score based on the markers, wherein the risk score represents a chance that the current application represents first party fraud.

2. The system of claim 1, wherein the markers comprise the total number of the matching applications and the variance among identity information of the identity linking keys in the matching applications.

3. The system of claim 1, wherein the markers comprise the frequency between the matching applications.

4. The system of claim 3, wherein the frequency comprises multiple time windows.

5. The system of claim 1, wherein the markers further comprise a type of application.

6. The system of claim 5, wherein the type of application comprises unsecured banking credit line application, an overdraft protection application, or a cellphone application.

7. The system of claim 1, wherein the commodity is a good or service.

8. The system of claim 7, wherein the good is a cellphone.

9. The system of claim 1, wherein the commodity is an unsecured line of credit.

10. The system of claim 9, wherein the unsecured line of credit comprises a credit card.

11. A method comprising:
obtaining identity information from a current application comprising identity information;
receiving a history of activity of consumers from a plurality of prior individual applications containing;
using a search module that searches for matching applications between the current application and the prior individual applications based on one or more identity linking keys, wherein the identity linking keys are matches of identity characteristics between the matching applications;
using a generation module which generates markers that are indicative of first party fraud based the identity linking keys in the matching applications, wherein the markers comprise a variance among identity information of the identity linking keys in the matching applications, a frequency between the matching applications, or a number of the matching applications; and
using a predictive module which computes a risk score based on the markers, wherein the risk score represents a chance that the current application represents first party fraud.

12. The method of claim 11, wherein the markers comprise the total number of the matching applications and the variance among identity information of the identity linking keys in the matching applications.

13. The method of claim 11, wherein the markers comprise the frequency between the matching applications.

14. A system comprising:
a search module that searches for matching applications between a current application and prior applications based on one or more identity linking keys, wherein the identity linking keys are matches of identity characteristics between the matching applications;
a generation module which generates markers that are indicative of first party fraud based the identity linking keys in the matching applications, wherein the markers comprise a variance among identity information of the identity linking keys in the matching applications, a frequency between the matching applications, or a number of the matching applications; and
a predictive module which computes a risk score based on the markers.

15. The system of claim 14, wherein the markers comprise the total number of the matching applications and the variance among identity information of the identity linking keys in the matching applications.

16. The system of claim 14, wherein the markers comprise the frequency between the matching applications.
